(19) United States
(12) Patent Application Publication
(10) Pub. No.: US 2018/0183138 A1
(43) Pub. Date: Jun. 28, 2018

(54) Antenna and User Equipment

(71) Applicant: ZTE CORPORATION, Shenzhen City, Guangdong (CN)

(72) Inventor: Xiaoqi CHENG, Shenzhen (CN)

(73) Assignee: ZTE Corporation, Guangdong (CN)

(21) Appl. No.: 15/738,130

(22) PCT Filed: Aug. 21, 2015
(86) PCT No.: PCT/CN2015/087832

§ 371 Date: Dec. 20, 2017

(30) Foreign Application Priority Data
Jun. 24, 2015 (CN) 201510354981.4

(51) Int. Cl. H01Q 1/24; H01Q 1/38; H04M 1/02

(52) U.S. Cl. CPC H01Q 1/243; H01Q 1/38; H01Q 5/371; H04M 1/0283; H04M 1/0277

(57) ABSTRACT

Provided are an antenna and a user equipment. The antenna includes a mainboard PCB 1, a metal frame 2, an antenna radiation element 3, a first and second feeding branch element 31, 32, a grounding element 4, a feeding point 7, and a clearance area 8. The mainboard PCB 1 is connected to the metal frame 2 via grounding element 4; the antenna radiation element 3 is arranged in clearance area 8 located at an upper side of the mainboard PCB 1; the metal frame 2 and the antenna radiation element 3 are arranged on a perimeter of a user equipment to form a user equipment frame, and a first and second gap 21, 22 are provided between metal frame 2 and antenna radiation element 3; and the feeding point 7 is connected to the antenna radiation element 3 via the first and second feeding branch element 31, 32, separately.

### TECHNICAL FIELD

The present disclosure relates to the field of communications, and more particularly to an antenna and a user equipment.

### BACKGROUND

When people pay attention to the performance and quality of mobile phones, requirements on appearance and texture are much stricter. Here, particularly for current fourth generation mobile communication (4G) mobile phones, ultra-thin and metal-frame mobile phones are more and more popular with consumers on the current market. However, in the presence of a metal frame, it is difficult for an electromagnetic wave to be effectively radiated and received, so that the efficiency of a mobile phone antenna will be reduced, and meanwhile, space reserved for designing the mobile phone antenna is further compressed.

Recently, in metal-frame mobile phones, particularly some highly-favored 4G mobile phones at current, launched by many mobile phone manufacturers, metal frames are designed to serve as part of mobile phone antennae. However, it is difficult for these mobile phone antennae based on metal frames to cover all bands of a Long Term Evolution (LTE) system. In addition, it is necessary to introduce an additional tunable switch module, antenna branch element and electrical connecting member on the basis of the metal frame in most cases.

As a result, a large space is occupied. Moreover, the additional tunable switch module, antenna branch element and electrical connecting member are introduced, thereby certainly increasing the design cost and complexity.

Any effective solution to the problem in the related art that an antenna occupies a large space has not been proposed yet at present.

### SUMMARY

To solve the above-mentioned technical problem, the present disclosure provides an antenna and a user equipment.

According to an aspect of the present disclosure, an antenna is provided. The antenna includes a mainboard Printed Circuit Board (PCB) 1, a metal frame 2, an antenna radiation element 3, a first feeding branch element 31, a second feeding branch element 32, a grounding element 4, a feeding point 7, and a clearance area 8.

The mainboard PCB 1 is connected to the metal frame 2 via the grounding element 4.

The antenna radiation element 3 is arranged in the clearance area 8 located at an upper side of the mainboard PCB 1.

The metal frame 2 and the antenna radiation element 3 are arranged on a perimeter of a user equipment to form a frame of the user equipment, and a first gap 21 and a second gap 22 are provided between the metal frame 2 and the antenna radiation element 3.

The feeding point 7 is connected to the antenna radiation element 3 via the first feeding branch element 31 and the second feeding branch element 32, separately.

In an exemplary embodiment, the antenna further includes: a first matching circuit 5 and a second matching circuit 6. Herein, the first matching circuit 5 and the second matching circuit 6 are arranged on the mainboard PCB 1; one end of the first matching circuit 5 is connected to the antenna radiation element 3 via the first feeding branch element 31, and the other end of the first matching circuit 5 is connected to the second matching circuit 6 and the feeding point 7 separately. And one end of the second matching circuit 6 is connected to the antenna radiation element 3 via the second feeding branch element 32, and the other end of the second matching circuit 6 is connected to the first matching circuit 5 and the feeding point 7 separately.

In an exemplary embodiment, the mainboard PCB 1 includes: a dielectric substrate 11 and a metal ground 12 formed by a metal coated area on the back of the dielectric substrate 11.

The metal ground 12 is connected to the metal frame 2 via the grounding element 4.

The first matching circuit 5 and the second matching circuit 6 are arranged on the dielectric substrate 11.

In an exemplary embodiment, both the metal frame 2 and the antenna radiation element 3 are of a symmetric U-shaped structure. The first gap 21 and the second gap 22 have the same gap size, and the first gap 21 and the second gap 22 are symmetrically arranged at two sides of the frame of the user equipment.

In an exemplary embodiment, the first feeding branch element 31 is connected to the antenna radiation element 3 at a central position inside the U-shaped structure of the antenna radiation element 3, and the second feeding branch element 32 is connected to the antenna radiation element 3 at one side of the central position inside the U-shaped structure of the antenna radiation element 3.

The first feeding branch element 31 is arranged to control a low-frequency part by using a microstrip straight-line form.

The second feeding branch element 32 is arranged to control a high-frequency part by using a microstrip tapered-line form.

In an exemplary embodiment, the low-frequency part includes: 698 MHz to 960 MHz, and the high-frequency part includes: 1710 MHz to 2690 MHz.

In an exemplary embodiment, the second feeding branch element 32 adopts a trapezoidal microstrip tapered-line form.

In an exemplary embodiment, the first matching circuit 5 is arranged for low-pass filtering, and the second matching circuit 6 is arranged for high-pass filtering.

In an exemplary embodiment, the first matching circuit 5 and the second matching circuit 6 include lumped element capacitors and inductors.

According to another aspect of the present disclosure, a user equipment is also provided. The user equipment includes the above-mentioned antenna.

By means of the present disclosure, the adopted antenna includes a mainboard PCB 1, a metal frame 2, an antenna radiation element 3, a first feeding branch element 31, a second feeding branch element 32, a grounding element 4, a feeding point 7, and a clearance area 8. Herein, the mainboard PCB 1 is connected to the metal frame 2 via the grounding element 4; the antenna radiation element 3 is arranged in the clearance area 8 located at an upper side of the mainboard PCB 1; the metal frame 2 and the antenna radiation element 3 are arranged on a perimeter of a user equipment to form a frame of the user equipment, and a first gap 21 and a second gap 22 are provided between the metal frame 2 and the antenna radiation element 3; and the feeding point 7 is connected to the antenna radiation element 3 via the first feeding branch element 31 and the second feeding branch element 32, separately. Therefore, by using the antenna, the problem that an antenna occupies a large space is solved, thereby reducing volume occupied by the antenna.

### BRIEF DESCRIPTION OF DRAWINGS

The drawings illustrated herein are intended to provide a further understanding for the present disclosure, and form a part of the present application. Exemplary embodiments and illustrations thereof in the present disclosure are intended to explain the present disclosure, and do not form improper limits to the present disclosure. In the drawings:

FIG. 1 is a structure diagram of an antenna according to an embodiment of the present disclosure.

FIG. 2 is an alternative structure diagram of an antenna according to an embodiment of the present disclosure.

FIG. 3 is a simulating curve chart of a return loss of the antenna as shown in FIG. 1.

FIG. 4 is a structure diagram of a first matching circuit of the antenna as shown in FIG. 2.

FIG. 5 is a structure diagram of a second matching circuit of the antenna as shown in FIG. 2.

FIG. 6 is a simulating curve chart of a return loss of the antenna as shown in FIG. 2.

### DETAILED DESCRIPTION

The present disclosure will be illustrated hereinbelow with reference to the drawings and in conjunction with the embodiments in detail. It is important to note that the embodiments in the present application and the characteristics in the embodiments may be combined with each other under the condition of no conflicts.

Other features and advantages of the present disclosure will be elaborated in the following description, and become obvious partially from the description or are understood by implementing the present disclosure. The purposes and other advantages of the present disclosure can be implemented and obtained by means of structures specially pointed out in the description, the claims and the drawings.

To make a person skilled in the art better understand the solution of the present disclosure, the technical solution in embodiments of the present disclosure will be clearly and completely described hereinbelow with reference to the drawings in the embodiments of the present disclosure. It is apparent that the described embodiments are only a part of embodiments of the present disclosure, not all embodiments. On the basis of the embodiments of the present disclosure, all other embodiments obtained on the premise of no creative work of a person of ordinary skill in the art shall fall within the scope of protection of the present disclosure.

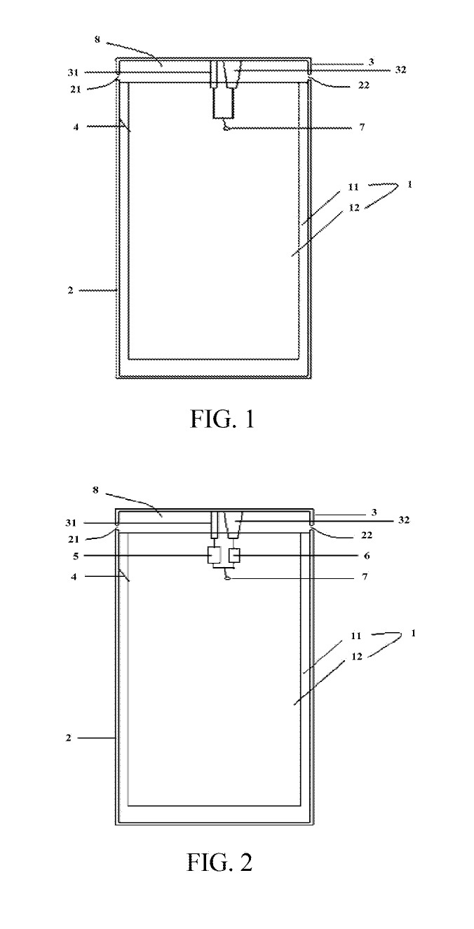

An embodiment of the present disclosure provides an antenna. FIG. 1 is a structure diagram of an antenna according to an embodiment of the present disclosure. As shown in FIG. 1, the antenna includes: a mainboard PCB 1, a metal frame 2, an antenna radiation element 3, a first feeding branch element 31, a second feeding branch element 32, a grounding element 4, a feeding point 7, and a clearance area 8.

The mainboard PCB 1 is connected to the metal frame 2 via the grounding element 4.

The antenna radiation element 3 is arranged in the clearance area 8 located at an upper side of the mainboard PCB 1.

The metal frame 2 and the antenna radiation element 3 are arranged on a perimeter of a user equipment to form a frame of the user equipment, and a first gap 21 and a second gap 22 are provided between the metal frame 2 and the antenna radiation element 3.

The feeding point 7 is connected to the antenna radiation element 3 via the first feeding branch element 31 and the second feeding branch element 32, separately.

By means of the above-mentioned antenna, a manner of connecting the two feeding branch elements with the antenna radiation element 3 separately is adopted, so that a sufficient broadband can be obtained without an additional tuning switch. Thus, compared with an antenna in the related art, a problem that an antenna occupies a large space is solved, thereby reducing volume occupied by the antenna.

In an exemplary embodiment, the above-mentioned user equipment includes: equipment integrated with an antenna, such as a mobile phone and a tablet computer and the like.

FIG. 2 is an alternative structure diagram of an antenna according to an embodiment of the present disclosure. As shown in FIG. 2, as an exemplary embodiment, the antenna further includes a first matching circuit 5 and a second matching circuit 6. Herein, the first matching circuit 5 and the second matching circuit 6 are arranged on the mainboard PCB 1. One end of the first matching circuit 5 is connected to the antenna radiation element 3 via the first feeding branch element 31, and the other end of the first matching circuit 5 is connected to the second matching circuit 6 and the feeding point 7 separately. One end of the second matching circuit 6 is connected to the antenna radiation element 3 via the second feeding branch element 32, and the other end of the second matching circuit 6 is connected to the first matching circuit 5 and the feeding point 7 separately.

In an exemplary embodiment, the mainboard PCB 1 includes: a dielectric substrate 11 and a metal ground 12 formed by a metal coated area on the back of the dielectric substrate 11. Herein, the metal ground 12 is connected to the metal frame 2 via the grounding element 4; and the first matching circuit 5 and the second matching circuit 6 are arranged on the dielectric substrate 11.

In an exemplary embodiment, both the metal frame 2 and the antenna radiation element 3 are of a symmetric U-shaped structure. The first gap 21 and the second gap 22 have the same gap size, and the first gap 21 and the second gap 22 are symmetrically arranged at two sides of the frame of the user equipment.

In an exemplary embodiment, the first feeding branch element 31 is connected to the antenna radiation element 3 at a central position inside the U-shaped structure of the antenna radiation element 3, and the second feeding branch element 32 is connected to the antenna radiation element 3 at one side of the central position inside the U-shaped structure of the antenna radiation element 3. Herein, the first feeding branch element 31 is arranged to control a low-frequency part by using a microstrip straight-line form; and the second feeding branch element 32 is arranged to control a high-frequency part by using a microstrip tapered-line form.

In an exemplary embodiment, the low-frequency part includes: 698 MHz to 960 MHz, and the high-frequency part includes: 1710 MHz to 2690 MHz.

In an exemplary embodiment, the second feeding branch element 32 adopts a trapezoidal microstrip tapered-line form.

In an exemplary embodiment, the first matching circuit 5 is arranged for low-pass filtering, and the second matching circuit 6 is arranged for high-pass filtering.

In an exemplary embodiment, the first matching circuit 5 and the second matching circuit 6 include lumped element capacitors and inductors.

An embodiment of the present disclosure also provides a user equipment. The user equipment adopts the above-mentioned antenna.

In an exemplary embodiment, the above-mentioned user equipment is handheld equipment, such as a smart phone and a tablet computer and the like.

To more clearly describe the embodiments of the present disclosure, description and illustration will be made hereinbelow in conjunction with an alternative embodiment.

The alternative embodiment of the present disclosure provides an antenna of a metal-frame mobile phone, to implement a 4G broadband technology by using a simple and effective manner on the basis of a metal frame.

To solve the above-mentioned technical problem, the mobile phone antenna provided in the alternative embodiment of the present disclosure includes:

a mainboard PCB 1, a metal frame 2, an antenna radiation element 3, two feeding branch elements 31, 32, a grounding element 4, two matching circuits 5, 6, a feeding point 7, and a clearance area 8.

Alternatively, the mainboard PCB 1 includes a dielectric substrate 11 and a metal ground 12 with a back copper-coated area.

Alternatively, the metal frame 2 and the antenna radiation element 3 constitute a frame of a mobile phone; the antenna radiation element 3 is located in the clearance area at an upper side of the PCB 1, the metal frame 2 and the antenna radiation element 3 are attached to the perimeter of the mobile phone PCB, and a pair of gaps with the same size is arranged symmetrically between the metal frame 2 and the antenna radiation element 3; and the grounding element 4 is connected to the metal frame 2 and the PCB metal ground 12.

Alternatively, the antenna radiation element 3 serving as a part of the metal frame of the mobile phone is connected to the two feeding branch elements 31, 32.

Alternatively, the feeding branch element 31 adopts a microstrip straight-line form, and is located in the center of the antenna body 3, and is connected to the matching circuit network 5, and controls a low-frequency part (680-960 MHz) of LTE. And the feeding branch element 32 adopts a microstrip tapered-line form, and is located at one side of the antenna body 3, and is connected to the matching circuit network 6, and controls a high-frequency part (1710-2690 MHz) of LTE.

Alternatively, both the two matching circuits 5, 6 are located on the dielectric substrate 11, and include lumped element capacitors and inductors. Herein, the matching circuit 5 acts for low-pass filtering, and the matching circuit 6 acts for high-pass filtering, and the two matching circuit networks are led out from the same feeding point 7 on the PCB 1 separately.

The solution in the alternative embodiment of the present disclosure will be illustrated with FIG. 2 hereinbelow in detail.

In FIG. 2, 1 represents a mainboard PCB of a mobile phone, and a frame of the mobile phone includes a metal frame 2 and an antenna radiation element 3. Herein, a pair of symmetric gaps 21, 22 (located between the metal frame 2 and the antenna radiation element 3) is provided on the frame of the mobile phone, and the widths of the gaps may be 0.2 mm. 4 represents a grounding element, and 5 and 6 represent two matching circuits, 31 and 32 represent two feeding branch elements of an antenna, 7 represents a coaxial feeding point, and 8 represents a clearance area of the antenna.

The size of the PCB 1 may be 72 mm*61 mm, and the PCB includes a dielectric substrate 11 and a metal ground 12 with a back copper-coated area. Herein, the dielectric substrate 11 may be made of Rogers RO4003, of which the dielectric constant is 3.55. The antenna radiation element 3 is formed by the metal frame of the mobile phone, and is located in the clearance area at an upper side of the PCB 1 and is connected to the two feeding branch elements 31, 32. The grounding element 4 is connected to the metal frame 2 and the metal ground 12 with the copper-coated area, and the high/low-frequency bandwidth of the antenna can be adjusted by appropriately adjusting a grounding position thereof, and the grounding element can be replaced with a metal elastic sheet.

The two feeding branch elements are located in the clearance area of the antenna at an upper side of the PCB 1. Herein, the feeding branch element 31 adopts a microstrip straight-line form, and is located in the center of the antenna body 3, and is connected to the matching circuit network 5, and controls a low-frequency part (698-960 MHz) of LTE. And the feeding branch element 32 adopts a microstrip tapered-line form, and is located at one side of the antenna body 3, and is connected to the matching circuit network 6, and controls a high-frequency part (1710-2690 MHz) of LTE. The microstrip tapered line is of a trapezoidal shape, and is mainly intended to better realize in-band impedance matching of high frequency 2.5-2.7 GHz, thereby improving the in-band performance.

Both the two matching circuits 5, 6 are located on the dielectric substrate 11, and include lumped element capacitors and inductors. Herein, the matching circuit 5 acts for low-pass filtering, the matching circuit 6 acts for high-pass filtering, and the two matching circuit networks are led out from the same feeding point 7 on the PCB 1 separately.

In the above-mentioned alternative embodiment, a metal frame radiation element and matching networks fed by two branches are just utilized to achieve a smaller space occupation. And due to no introduction of a tuning switch module and an auxiliary antenna branch, the cost is saved, and the design is simplified. Moreover, the LTE broadband can be realized, and the solution can also be used in the design of an antenna of an all-metal mobile phone.

The working effect of double-branch feeding adopted in the alternative embodiment of the present disclosure will be illustrated hereinbelow.

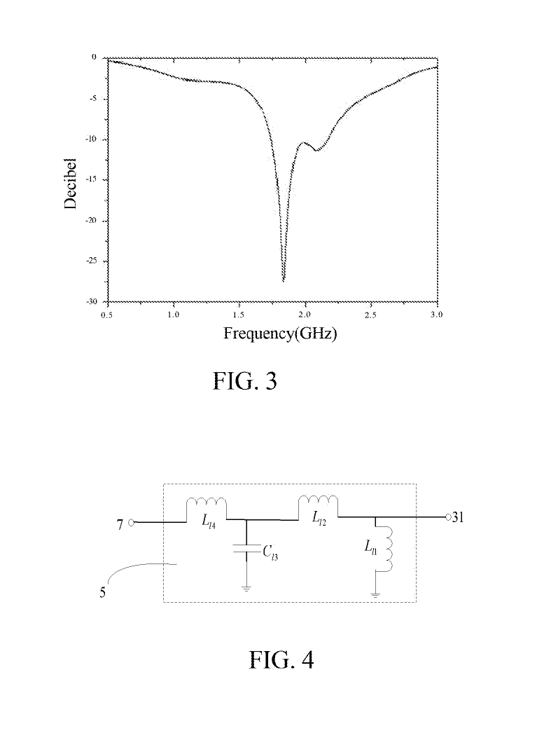

FIG. 3 is a simulating curve chart of a return loss of the antenna as shown in FIG. 1, namely an antenna not added with any matching circuit network. A coaxial feeding point 7 is directly connected to two feeding branch elements 31, 32. From the simulating curve, it can be seen that two resonant modes can be excited by means of only an antenna radiation element 3 of a metal frame, and the resonant modes which can be excited by the antenna radiation element 3 are associated with connecting positions of the two feeding branch elements. In the present alternative embodiment, to obtain the required bandwidth, two microstrip lines are connected with the center and one side of the antenna radiation element 3 separately for feeding, and bandwidth of which the return loss is smaller than −6 dB can cover a working band of 1.6-2.4 GHz.

From a simulating result, it can be seen that without addition of the antenna matching circuit network, the antenna radiation element 3 can generate two resonances by optimizing the connecting positions of the two feeding branch elements, to generate a working band of 1.6-2.4 GHz. Therefore, the antenna can obtain a larger bandwidth by adopting a double-feeding form.

The working effect of an antenna adopting a matching circuit network in the alternative embodiment of the present disclosure will be illustrated hereinbelow.

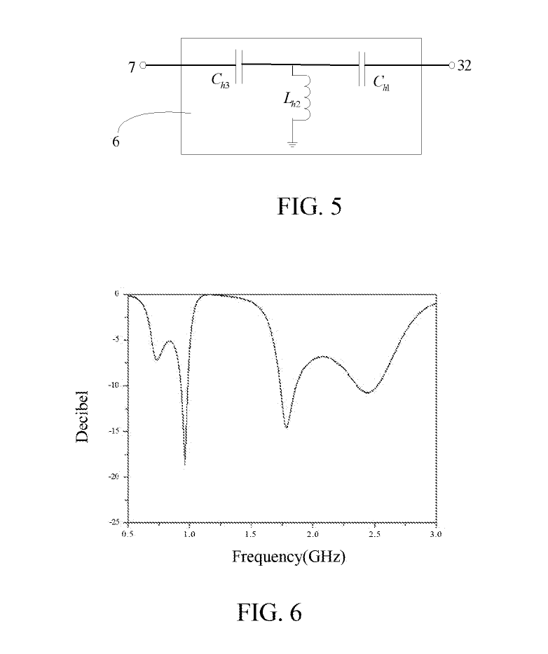

FIG. 4 and FIG. 5 are circuit diagrams of matching networks of the antenna as shown in FIG. 2 respectively.

As shown in FIG. 4, a matching circuit 5 is located on a dielectric substrate 11, and fed by a radio frequency coaxial feeding point 7, and connected to a feeding branch element 31 and composed of parallel capacitors and series and parallel inductors. The matching circuit network mainly adjusts an LTE low-frequency (698-960 MHz) part of the antenna, and can change a low-frequency bandwidth and an in-band return loss by optimizing the value of each element. For example, the low-frequency bandwidth can be increased by appropriately increasing parallel inductance L11, and the low-frequency in-band return loss is improved by reducing parallel capacitance C13, and the high-frequency is essentially unchanged. Just from the characteristics of the matching circuit 5, it can be seen that it is approximate to low-pass filtering.

As shown in FIG. 5, a matching circuit 6 is also located on the dielectric substrate 11, and fed by the radio frequency coaxial feeding point 7, and connected to a feeding branch element 32 and composed of parallel inductors and series capacitors. The matching circuit network mainly adjusts an LTE high-frequency (1710-2690 MHz) part of the antenna, and can improve the high-frequency bandwidth and performance by optimizing the value of each element. For example, if parallel inductance Lh2 is appropriately increased, then resonance deepens at a high frequency of 1.71 GHz, and resonance shallows at a frequency of 2.69 GHz, and the low-frequency is influenced little. Just from the characteristics of the matching circuit 6, it can be seen that it is approximate to high-pass filtering.

From the above-mentioned simulating results, it can be seen that the two matching circuits 5, 6 are approximate to low-pass filtering and high-pass filtering respectively, and have better band elimination characteristics at corresponding high-frequency and low-frequency bands, so two corresponding feeding paths of the antenna have better isolation.

Alternatively, to meet more band demands, the position of the grounding element 4 can be appropriately adjusted.

FIG. 6 shows a simulating curve chart of a return loss of the antenna as shown in FIG. 2. From FIG. 6, it can be seen that after matching networks are added, the antenna has two resonant bands, and can well cover the whole LTE working band (698-960 MHz and 1710-2690 MHz), and in-band return losses of two passbands are smaller than −6 dB separately. Moreover, the isolation of two passbands is high. Therefore, technical requirements of an antenna of a broadband 4G mobile phone in mobile communications are met.

To give consideration to both appearance and performance, the above-mentioned solution provided in the alternative embodiment of the present disclosure can be well applied to a design of an antenna of a metal-frame mobile phone. Moreover, the solution provided in the alternative embodiment of the present disclosure can also add a tuning switch module or introduce antenna branch elements and slots, to obtain a better effect. Moreover, the antenna radiation element 3 described in the above-mentioned embodiments and alternative embodiment of the present disclosure may be of other shapes in addition to a U shape.

To sum up, according to the solution provided in the above-mentioned embodiments and alternative embodiment of the present disclosure, an antenna radiation element 3 based on a metal frame is combined with novel matching circuit networks 5, 6, and two branch elements 31, 32 are introduced and fed by a feeding point 7, so that a working band of the low-frequency bandwidth 698-960 MHz and the high-frequency bandwidth 1710-2690 MHz is implemented, and the band width is broadened, the bandwidth of the antenna and the isolation of the high-frequency and the low-frequency are improved by double-branch feeding and novel matching, and multi-band using requirements of 4G of a radio terminal are met. Moreover, in the above-mentioned technical solution an antenna radiation element and matching networks of a metal mobile phone frame are used to achieve smaller space occupation, and can be used in design of an antenna of an all-metal mobile phone. Moreover, the above-mentioned embodiment of the present disclosure can realize a 4G broadband without addition of a tuning switch module and introduction of an additional antenna branch, therefore the cost is saved, and the design is simple and feasible, and the embodiment can be widely applied to a 4G mobile phone with an ultrathin metal frame.

### INDUSTRIAL APPLICABILITY

From the above-mentioned description, it can be seen that the present disclosure adopts a manner of connecting two feeding branch elements with an antenna radiation element 3 separately, so that a sufficient broadband can be obtained without an additional tuning switch. Thus, compared with an antenna in the related art, a problem that an antenna occupies a large space is solved, thereby reducing volume occupied by the antenna.

The above embodiments are only the alternative embodiments of the present disclosure, and not intended to limit the present disclosure. As will occur to a person skilled in the art, the present disclosure may have various modifications and changes. Any modifications, equivalent replacements or improvements made within the essence and principle of the present disclosure should fall within the scope of protection of the present disclosure.

What is claimed is:

1. An antenna, comprising: a mainboard Printed Circuit Board, PCB, (1), a metal frame (2), an antenna radiation element (3), a first feeding branch element (31), a second feeding branch element (32), a grounding element (4), a feeding point (7), and a clearance area (8), wherein
the mainboard PCB (1) is connected to the metal frame (2) via the grounding element (4);
the antenna radiation element (3) is arranged in the clearance area (8) located at an upper side of the mainboard PCB (1);
the metal frame (2) and the antenna radiation element (3) are arranged on a perimeter of a user equipment to form a frame of the user equipment, and a first gap (21) and a second gap (22) are provided between the metal frame (2) and the antenna radiation element (3); and
the feeding point (7) is connected to the antenna radiation element (3) via the first feeding branch element (31) and the second feeding branch element (32), separately.

2. The antenna according to claim 1, further comprising: a first matching circuit (5) and a second matching circuit (6), wherein
the first matching circuit (5) and the second matching circuit (6) are arranged on the mainboard PCB (1); one end of the first matching circuit (5) is connected to the antenna radiation element (3) via the first feeding branch element (31), and the other end of the first matching circuit (5) is connected to the second matching circuit (6) and the feeding point (7) separately; and one end of the second matching circuit (6) is connected to the antenna radiation element (3) via the second feeding branch element (32), and the other end of the second matching circuit (6) is connected to the first matching circuit (5) and the feeding point (7) separately.

3. The antenna according to claim 2, wherein the mainboard PCB (1) comprises: a dielectric substrate (11) and a metal ground (12) formed by a metal coated area on the back of the dielectric substrate (11), wherein
the metal ground (12) is connected to the metal frame (2) via the grounding element (4); and
the first matching circuit (5) and the second matching circuit (6) are arranged on the dielectric substrate (11).

4. The antenna according to claim 2, wherein
both the metal frame (2) and the antenna radiation element (3) are of a symmetric U-shaped structure; and the first gap (21) and the second gap (22) have same gap size, and the first gap (21) and the second gap (22) are symmetrically arranged at two sides of the frame of the user equipment.

5. The antenna according to claim 4, wherein the first feeding branch element (31) is connected to the antenna radiation element (3) at a central position inside the U-shaped structure of the antenna radiation element (3), and the second feeding branch element (32) is connected to the antenna radiation element (3) at one side of the central position inside the U-shaped structure of the antenna radiation element (3), wherein
the first feeding branch element (31) is arranged to control a low-frequency part by using a microstrip straight-line form; and
the second feeding branch element (32) is arranged to control a high-frequency part by using a microstrip tapered-line form.

6. The antenna according to claim 5, wherein
the low-frequency part comprises: 698 MHz to 960 MHz, and the high-frequency part comprises: 1710 MHz to 2690 MHz.

7. The antenna according to claim 5, wherein
the second feeding branch element (32) adopts a trapezoidal microstrip tapered-line form.

8. The antenna according to claim 5, wherein
the first matching circuit (5) is arranged for low-pass filtering; and
the second matching circuit (6) is arranged for high-pass filtering.

9. The antenna according to claim 1, wherein
the first matching circuit (5) and the second matching circuit (6) include lumped element capacitors and inductors.

10. A user equipment, comprising the antenna according to claim 1.

11. A user equipment, comprising the antenna according to claim 2.

12. A user equipment, comprising the antenna according to claim 3.

13. A user equipment, comprising the antenna according to claim 4.

14. A user equipment, comprising the antenna according to claim 5.

15. A user equipment, comprising the antenna according to claim 6.

16. A user equipment, comprising the antenna according to claim 7.

17. A user equipment, comprising the antenna according to claim 8.

18. A user equipment, comprising the antenna according to claim 9.
